(19) United States
(12) Patent Application Publication
(10) Pub. No.: US 2009/0164054 A1
(43) Pub. Date: Jun. 25, 2009

(54) GEOREFERENCED WORK ORDER COMMUNICATION FOR CROP PRODUCTION

(75) Inventors: TODD A. PETERSON, JOHNSTON, IA (US); DOUGLAS L. GARDNER, JOHNSTON, IA (US); DOUGLAS J. HOUSER, SLATER, IA (US)

Correspondence Address: MCKEE, VOORHEES & SEASE, P.L.C.;ATTN: PIONEER HI-BRED, 801 GRAND AVENUE, SUITE 3200, DES MOINES, IA, 50309-2721, US

(73) Assignee: PIONEER HI-BRED INTERNATIONAL, INC., JOHNSTON, IA (US)

(21) Appl. No.: 12/337,881

(22) Filed: Dec. 18, 2008

Related U.S. Application Data
(60) Provisional application No. 61/015,708, filed on Dec. 21, 2007.

(51) Int. Cl. G06F 19/00; G06F 17/30

(52) U.S. Cl. 701/2; 707/104.1; 707/E17.044

(57) ABSTRACT

A method for managing work operations performed by an agricultural machine includes defining a work order to include a prescribed work operation and a location for the prescribed work operation. The work order may then be electronically communicated to an agricultural machine. The agricultural machine may then determine if an attempt to perform a work operation inconsistent with the work order is being made. If so, the agricultural machine may prevent the work operation.

### CROSS-REFERENCE TO RELATED APPLICATIONS

This application claims priority under 35 U.S.C. §119(e) to provisional application Ser. No. 61/015,708 filed Dec. 21, 2007, herein incorporated by reference in its entirety.

### FIELD OF THE INVENTION

The field of the invention relates to crop production.

### BACKGROUND

Crop production continues to become more complex for a variety of reasons. One reason is that the availability of new technologies, including seed products with new genetic traits provide more choices for producers and more complex decision-making is required.

Another reason is that as farm operations grow and consolidate, more farm operators must coordinate activities and manage others involved in the increasingly complex field operations from a distance. As the number of employees and simultaneous field operations increases, there is a greater chance that instructions are misinterpreted and/or a different field operation, application, or transportation is performed than the one intended by the manager.

### BRIEF SUMMARY OF THE INVENTION

A method for managing work operations performed by an agricultural machine includes defining a work order to include a prescribed work operation and a location for the prescribed work operation. The work order may then be electronically communicated to an agricultural machine. The agricultural machine may then determine if an attempt to perform a work operation inconsistent with the work order is being made. If so, the agricultural machine may prevent the work operation.

### BRIEF DESCRIPTION OF THE DRAWINGS

FIG. 1 is pictorial representation showing the use of work orders.

FIG. 2 is a display illustrating a work order.

FIG. 3 is a block diagram illustrating a system for controlling agricultural equipment using a work order.

### DETAILED DESCRIPTION OF THE PREFERRED EMBODIMENT

A method for managing work operations performed using an agricultural machine is provided. Work orders are formed to describe prescribed work operations in a manner which can be interpreted by agricultural equipment as well as human operators. The use of work orders helps insure that correct work operations are performed at the correct locations, while preventing work operations that may adversely affect crop production.

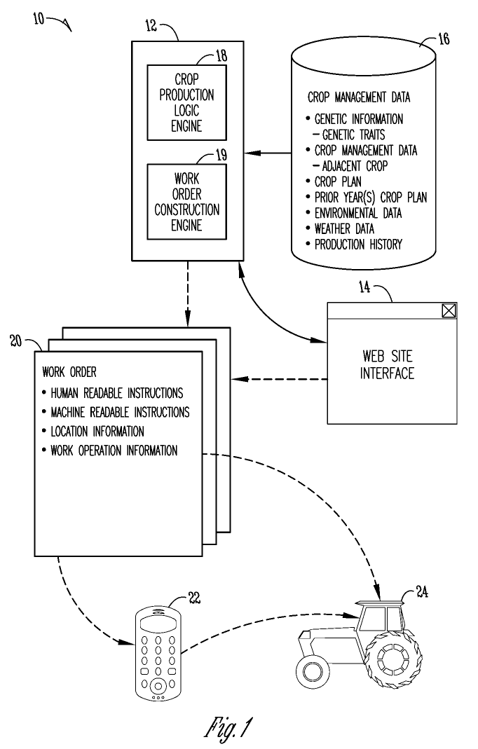

FIG. 1 is a pictorial representation showing a system 10 for creating and using work orders. In the system 10, an application 12 is shown which may include or more components. For example, the application 12 may include a crop production logic engine 18. A web site interface 14 may be used to access the application 12 which may be a web application.

A database 16 is in operative communication with the application 12. The database 16 may include crop management data such as, but not limited to genetic data, environmental data, weather data, crop plan data, production history, prior year crop plan data, and other information. The application 12 may be used to generate a work order 20. The work order 20 may contain human readable instructions as well as machine readable instructions. The instructions are used to define work operations to be performed and locations associated with the work operations. The work order 20 may then be electronically communicated to an agricultural machine 24. The work order 20 may be communicated to the agricultural machine 24 in various ways, including through a phone 22.

A farm manager or other user may use the application 12, through a web site interface 14 or otherwise to construct work orders 20 for different locations using a work order construction engine 19 of the application 12. The use of the work orders 20 allow the farm manager to ensure that appropriate operations will be performed at the correct location, by preventing workers from making mistakes.

In addition, the application 12 may assist the farm manager or other user in constructing the work orders 20 in a variety of ways. For example, the application 12 may include a crop production logic engine 18 which applies rules or logic to the work orders constructed by the user using a work order construction engine 19. The crop production logic engine 18 uses additional information in the database 16 to warn of potential concerns such as the work order not being consistent with the current crop plan, or the work order not being appropriate in view of other known crop management data. Thus, in this manner, the work orders which are constructed may be verified with or tested against known information to provide the farm manager or another user with information regarding the appropriateness of the work order before it is implemented. For example, before implementing a work order, the crop production logic engine 18 may consider genetic information about the crop planted or to be planted at a particular location, including genetic traits about the crop. The crop production logic engine 18 may also consider the impact of a particular operation on current or future crops at adjacent locations. Information about future crops may be obtained where appropriate future crop plans are provided.

For example, a farm manager may create a work order for spraying a particular herbicide on a crop at a particular location. The application 12 may review the work order and compare to known information regarding known genetic traits of the crop at the particular location, to ensure that the crop is genetically tolerant to the herbicide. If the crop does not include a genetic trait associated with tolerance to the herbicide, then the farm manager will be alerted that the work order should be modified.

Similarly, the application 12 may review the work order and compare it to known information such as genetic traits of the crop as well as past crop plans and genetic traits of past crops. For example, if a producer creates a work order for spraying a herbicide in a soybean field, the application 12 may compare this work order with information for the previous year and determine that corn with a herbicide resistant trait for the herbicide was present the previous year. In such an instance, the application 12 may recommend that a different herbicide be used which will eliminate volunteer corn in the soybean field.

By way of further example, the application 12 may review the work order and compare it to a site-specific weather forecast to further evaluate whether the field operation contained in the work order should be initiated. Thus, if rain was predicted or imminent at the location, the application 12 and its crop production logic engine 18 may determine that spraying a water soluble herbicide should not be initiated.

The information used in reviewing the work order may also include whether the seed product is a full season seed product or an earlier than full season seed product. If the planting date specified in the work order is too late in the season and the seed product is a full season seed product, then the application may indicate that an earlier than full season seed product should be used instead.

The information used in reviewing the work order may also include environmental information such as obtained from a weather database for the location where the seed is to be planted. Based on soil data or predicted values for soil data, planting depth associated with the planting defined in the work order can be examined. If the planting depth indicated by the farm manager is inconsistent with planting depth recommended by the application, then the farm manager may be notified and given the opportunity to alter the work order.

Where the work order is for a planting operation, the work order may also specify a planting rate. The application 12 may compare the planting rate to data in the database regarding high population stress traits of the seed product being planted, and suggest that higher or lower planting rates be used.

In addition to planting, the work order may relate to other operations such as harvesting grain, applying chemicals, tillage or other applications. The work order may relate to logistics associated with crop production, such as performing a work operation of hauling grain from a particular field to a particular grain bin. These are merely examples of how work orders may be reviewed using available data. The available data in the database 16 may include crop management data for a current crop, crop management data for previous crops at the same location, crop management data for adjacent fields. The crop management data may include genetic information, including genetic traits, environmental data such as soil data, weather data, and other types of data. The crop management data may also include seed product specific data in the form of recommended crop management practices for particular seed products.

The crop production logic engine 18 uses the available data in the database 16 to assist in determining if the work order being formed by the farm manager is supported by the available data in the database 16. Where an inconsistency is found, the user is alerted of the inconsistency so that the user may appropriately modify the work order.

Once complete, the work order 20 may be communicated to an agricultural machine such as a tractor 24. The work order may be communicated in various ways. For example, the work order may be placed on a memory card and transferred to the agricultural machine. Alternatively, the work order may be wireless transmitted to the agricultural machine directly or through an intermediary device, such as a phone 22. The phone 22 may include a Bluetooth, UWB, Wi-Fi, or other type of short range transceiver and the agricultural machine may be similarly equipped to allow for communication between the agricultural machine and the phone 22. Thus, the work order may be communicated to a phone 22 and then communicated from the phone 22 to the agricultural machine 24.

In this manner, once a work order is constructed, it may be reviewed by the application 12 and modified if necessary by a user such as a farm manager. Then the work order is distributed to a farm worker who is to carry out the work order according to the details provided in the work order using equipment 14.

The work order itself may include human readable as well as machine-readable information. Thus, the work order can be understood by the worker carrying out the work order as well as the machine used to carry out the work order, thus increasing the likelihood that the work order is performed as prescribed. The work order may be used to define any number of work operations associated with any number of tasks associated with crop production.

The machine 24 is adapted for interpreting the work order and determining if a work operation being performed is consistent with the work order or not. This can include determining GPS position of the machine 24 when asked to perform a work operation and determining if the GPS position of the machine 24 is consistent with the work order. For example, if the work operation is a planting operation, prior to allowing the planting, the machine 24 determines whether or not the machine 24 is within the boundaries of a field defined in the work order. If the machine 24 is not within the boundaries, then the machine 24 will alert the operator that it is being asked to perform a work operation which is inconsistent with the work order. The alert may be through a user interface such as a visual alert on a display or an audio alert through a speaker. In addition, the machine 24 may prevent itself from performing the work operation until the operator over-rides the work order. This may be performed where an intelligent control associated with the machine 24 which is used to interpret work orders is electrically connected with agricultural equipment controls. The agricultural equipment controls may include any number of types of electronic controls associated with agricultural equipment, including electronically actuated hydraulic controls associated with farm implements towed by a tractor.

The operator may be given an opportunity to override the work order, or the intelligent control may require an updated work order before proceeding. Where an updated work order is needed, the farm worker may contact a farm manager who will prepare and communicate the updated work order to the worker and the agricultural machine 24. Thus, the operator of the equipment would not be able to perform an operation inconsistent with a work order without the permission of the farm manager.

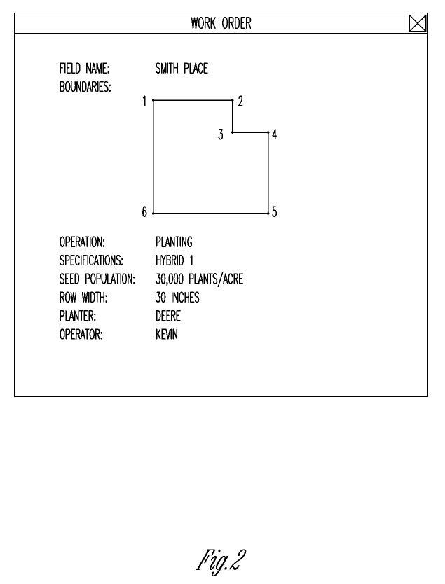

FIG. 2 illustrates one embodiment of a work order as constructed by a user of the application 12. The user is able to define a location, such as by field. The user may identify the field by name, such as “SMITH PLACE” as well as by geospatial boundaries. The geospatial boundaries may be specified in the form of a polygon defined by a series of points defining a field boundary. The work order also defines an operation to be performed, such as “PLANTING.” The work order includes the type of seed product being planted, “HYBRID1” as well as other specifications regarding the work operation to be performed. This may include a seed population, a row width, the identity of a particular planter to use, and a name of an operator who is to carry out the work operation. Of course, the work order may include other information as well that may be helpful in defining the work operation to be performed. Different work operations will have different specifications, and work operations can be used to define any type of activity associated with crop production and related activities.

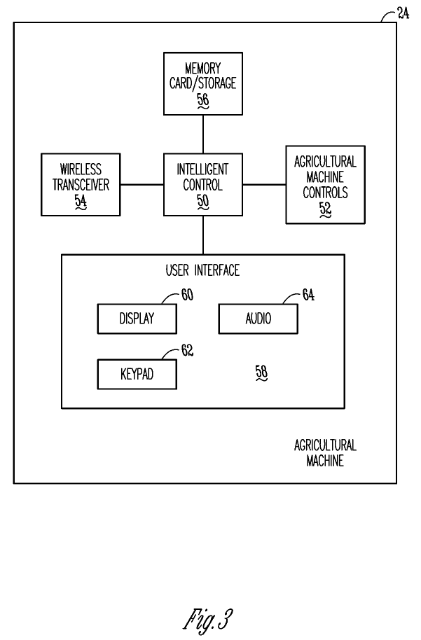

FIG. 3 is a block diagram illustrating one embodiment of an agricultural machine configured for use with work orders. In FIG. 3, the agricultural machine 24 is shown which may be a tractor, a combine, a self-propelled sprayer or other type of machine. An intelligent control 50 is electrically connected to agricultural machine controls 52. In this way, the intelligent control 50 can prevent a work operation from being performed if the work operation is inconsistent with the work order. The intelligent control 50 is also electrically connected to a user interface 58. The user interface may include a display 60, a keypad 62, or audio component 64. In this way, the user interface can communicate information to and from a user. The intelligent control 50 may receive a work order in various ways. One way a work order can be communicated to the intelligent control 50 is through a memory card or other storage device 56. Another way a work order can be communicated to the intelligent control 50 is using a wireless transceiver 54. The wireless transceiver 54 may be a Bluetooth, Wi-Fi, UWB, or other type of transceiver. The wireless transceiver 54 may communicate to a cell phone which is similarly equipped with transceiver as well as a cellular transceiver. Alternatively, the wireless transceiver 54 may be a cellular transceiver, a satellite transceiver, or other type of transceiver that allows for work orders to be received by the intelligent control 50.

Thus, a system of preparing and dispatching work orders may be used to coordinate efforts and management in large crop production operations to insure the proper action is implemented by a diverse and dispersed mobile mechanized workforce. Improved communication of intentions is provided by using geo-referenced field borders as a guide for work-order generation, and GPS-equipped mobile field equipment can be programmed to not operate (or at least request operator confirmation) if the operation is not being performed within a prescribed polygon (e.g. field boundary). Variations are contemplated in the manner in which the work order is specified, the various types of work operations that may be performed, the way in which a work order is communicated to a worker and agricultural equipment, as well as other variations.

What is claimed is:

1. A method for managing work operations performed by an agricultural machine, comprising:
defining a work order to include a prescribed work operation and a location for the prescribed work operation;
electronically communicating the work order to an agricultural machine;
determining by the agricultural machine if the agricultural machine is attempting to perform a work operation inconsistent with the work order;
if the work operation is inconsistent with the work order, preventing the agricultural machine from performing the work operation.

2. The method of claim 1 further comprising notifying a user of the agricultural machine of the work operation being inconsistent with the work order.

3. The method of claim 2 further comprising receiving a request from an operator of the agricultural machine to override the agricultural machine and perform the work operation.

4. The method of claim 3 further comprising over-riding the work order and allowing the agricultural machine to perform the work operation.

5. The method of claim 1 wherein the step of electronically communicating the work order to an agricultural machine includes electronically communicating the work order from a phone to the agricultural machine.

6. The method of claim 5 wherein the step of electronically communicating the work order to an agricultural machine further includes receiving a work order from a web site on the phone.

7. The method of claim 1 wherein the work order is constructed using a web-based service.

8. The method of claim 7 wherein the web-based service uses genetic information of a crop in constructing the work order.

9. The method of claim 7 wherein the web-based service verifies the work order is consistent with a crop using genetic information of the crop.

10. A method for managing crop production, comprising:
electronically defining a work order to include a prescribed crop production work operation and a location for the prescribed crop production work operation;
verifying the work order using crop production data associated with the location;
electronically communicating the work order to an agricultural machine;
determining by the agricultural machine if the agricultural machine is attempting to perform a work operation inconsistent with the work order;
if the work operation is inconsistent with the work order, preventing the agricultural machine from performing the work operation.

11. The method of claim 10 wherein the crop production data includes genetic information for seed planted at the location.

12. The method of claim 11 wherein the genetic information for seed planted at the location includes genetic traits of the seed.

13. The method of claim 12 wherein the genetic traits include herbicide tolerance traits.

14. The method of claim 10 wherein the crop production data includes genetic information for seed planted at a field adjacent to the location.

15. The method of claim 14 wherein the genetic information includes genetic traits of the seed.

16. The method of claim 15 wherein the genetic traits include herbicide tolerance traits.

17. The method of claim 10 wherein the crop production data includes crop production from previous years.

18. A system for managing crop production, comprising:
a work order engine adapted for defining a work orders including prescribed crop production work operations and geo-referenced location information for the prescribed crop production work operations;
a database comprising geo-referenced crop production information;
a web accessible user interface adapted to interface with the work order engine and the database to allow a user to create work order based on geo-referenced crop production information.

19. The system of claim 18 wherein the crop production information includes genetic information for seed.

20. The system of claim 18 wherein the genetic information includes genetic traits of the seed.
